(19) United States
(12) Patent Application Publication
(10) Pub. No.: US 2026/0200703 A1
(43) Pub. Date: Jul. 16, 2026

(54) Arrangement for Hoisting Machine in Forced-Drive Home Elevator and Home Elevator

(71) Applicant: SUZHOU MODERN FUJI ELEVATOR CO., LTD., Suzhou (CN)

(72) Inventors: Feifei Wu, Suzhou (CN); Shenrong Li, Suzhou (CN); Ying Lu, Suzhou (CN)

(73) Assignee: SUZHOU MODERN FUJI ELEVATOR CO., LTD., Suzhou (CN)

(21) Appl. No.: 19/435,955

(22) Filed: Dec. 30, 2025

(30) Foreign Application Priority Data
Jan. 10, 2025 (CN) 2025200588229

(51) Int. Cl. B66B 9/00; B66B 7/04; B66B 11/00; B66B 11/02; B66B 11/06

(52) U.S. Cl. CPC B66B 9/00; B66B 7/047; B66B 11/0005; B66B 11/005; B66B 11/02; B66B 11/06

(57) ABSTRACT

The present disclosure includes an arrangement for a hoisting machine in a forced-drive home elevator, including a hoistway installed with a frame, and a support bracket. A car is installed on the support bracket. The support bracket is slidably disposed in the frame. The hoisting machine is installed in the support bracket. Projections of the hoisting machine and the car on a horizontal plane do not overlap. A traction rope is fixed on a traction sheave of the hoisting machine. A crossbeam is arranged above the support bracket, and the traction rope is fixedly connected to the crossbeam. By arranging the hoisting machine on the support bracket, it is only necessary to fix the traction rope on the crossbeam in the hoistway without a guide pulley structure at the top of the hoistway, which implies no need to occupy the space at the top or bottom of the hoistway.

### CROSS REFERENCE TO RELATED APPLICATIONS

This disclosure claims priority to Chinese Patent Application No. CN202520058822.9, filed on January 10, 2025, entitled "Arrangement Structure of Hoisting Machine in Forced-Drive Home Elevator", the entire contents of which are incorporated herein by reference.

### FIELD

The present disclosure relates to the field of elevators, and in particular, to an arrangement for a hoisting machine in a forced-drive home elevator and a home elevator including the hoisting machine arrangement. The hoisting machine in the present disclosure is of a forced-drive type.

### BACKGROUND

Currently, the arrangement positions of hoisting machines in forced-drive home elevators on the market are mainly of two types: hoistway-external type and hoistway-internal type. Among them, the hoisting machine of the hoistway-external forced-drive home elevator is arranged outside the hoistway, requiring a dedicated installation space for the hoisting machine. The arrangement is inflexible and occupies extra household space. In some cases, it is even necessary to make a hole in the wall to place the hoisting machine, which is very inconvenient. Meanwhile, a guide pulley structure needs to be arranged at the top of the hoistway. The traction rope runs from the support bracket, winds around the guide pulley, and then connects downwards to the traction sheave of the hoisting machine. This reduces the space utilization of the hoistway and imposes high requirements on the height of the hoistway.

The hoisting machine of the hoistway-internal forced-drive home elevator is arranged at the bottom or the top of the hoistway. For a forced-drive home elevator with the hoisting machine located at the top of the hoistway, the hoisting machine needs to be connected to and reinforced with the top

of the building floor slab, and space for installing the hoisting machine needs to be reserved at the top of the hoistway. One end of the traction rope is connected upward to the traction sheave of the hoisting machine, and the other end of the traction rope is connected downward to the support bracket. For a forced-drive home elevator with the hoisting machine located at the bottom of the hoistway, space for installing the hoisting machine needs to be reserved at the bottom of the hoistway, and space for arranging guide pulleys needs to be reserved at the top of the hoistway. After the traction rope winds on the guide pulley, the two ends of the traction rope are respectively connected downward to the traction sheave of the hoisting machine and the support bracket.

Although the hoistway-internal forced-drive home elevator does not occupy extra household space of the customer, it occupies a large amount of space at the top or bottom of the hoistway. Compared with the hoistway-external forced-drive home elevator, the hoistway-internal forced-drive home elevator has higher requirements for the height of the hoistway, requiring an increased hoistway height to achieve installation. Therefore, the hoistway-external forced-drive home elevator increases installation costs due to the need for extra holes, while the hoistway-internal forced-drive home elevator increases installation costs due to the need to increase the hoistway height.

### SUMMARY

The purpose of the present disclosure is to provide an arrangement for a hoisting machine in a forced-drive home elevator, in which the hoisting machine is directly arranged on a support bracket, without reducing the space utilization rate of the hoistway.

To achieve the above purpose, the technical solution adopted by the present disclosure is:

An arrangement for a hoisting machine in a forced-drive home elevator, including: a hoistway installed with a frame, and a support bracket. A car is installed on the support bracket. The hoisting machine is of a forced-drive type. The support bracket is slidably disposed (slidingly set) in the frame. The hoisting machine is installed in the support bracket. The hoisting machine does not interfere with the car, that is, projections of the hoisting machine and the car on a horizontal plane do not overlap. A traction rope is fixed on a traction sheave of the hoisting machine. A crossbeam is fixedly arranged above the support bracket, and the upper end of the traction rope is fixedly connected to the crossbeam.

Further, in the aforementioned arrangement for a hoisting machine in a forced-drive home elevator, the hoisting machine is fixed on a bottom wall of the support bracket and located at a rear side of the car. The traction sheave in the hoisting machine protrudes backward out of the support bracket, and the traction rope on the traction sheave connects vertically upward to the crossbeam.

Further, in the aforementioned arrangement for a hoisting machine in a forced-drive home elevator, the hoisting machine is of a double-ended structure, and traction sheaves are arranged on both left and right ends of the hoisting machine. A left-right symmetry center line of the hoisting machine is vertically aligned with a left-right symmetry center line of the bottom wall of the support bracket. Two traction ropes on the two traction sheaves on the hoisting machine are both connected vertically upward to the crossbeam.

Further, in the aforementioned arrangement for a hoisting machine in a forced-drive home elevator, two mounting seats are arranged symmetrically left and right on the crossbeam. The two mounting seats are respectively vertically aligned with the two traction sheaves protruding backward out of the support bracket. The traction ropes on the two traction sheaves are respectively connected to the two mounting seats on the crossbeam.

Further, in the aforementioned arrangement for a hoisting machine in a forced-drive home elevator, the crossbeam is fixed to the top of the frame.

Further, in the aforementioned arrangement for a hoisting machine in a forced-drive home elevator, the crossbeam is fixed on the top wall of the hoistway.

Further, in the aforementioned arrangement for a hoisting machine in a forced-drive home elevator, guide shoes are arranged at upper and lower ends of both left and right side walls of the support bracket. Sliding grooves slidably cooperating with the two guide shoes on the same side are arranged in the frame.

Further, in the aforementioned arrangement for a hoisting machine in a forced-drive home elevator, the traction rope is a steel wire rope.

In some embodiments, an arrangement for a hoisting machine in a forced-drive home elevator is provided, wherein the home elevator includes a support bracket, a hoisting machine, and a traction rope. The hoisting machine is of a forced-drive type. The hoisting machine is fixedly installed on the support bracket and moves synchronously with the support bracket. The hoisting machine has a traction sheave. One end of the traction rope is wound on the traction sheave, and the other end of the traction rope protrudes from the traction sheave toward the back side of the support bracket, then extends vertically upward and is fixed. The hoisting machine is configured to drive the traction sheave to rotate, so that a length of the traction rope wound on the traction sheave increases or decreases, thereby driving the support bracket and the hoisting machine to move.

Further, the support bracket includes a vertical portion, a horizontal portion, and a connecting portion. The horizontal portion is located at a bottom end of the vertical portion and is configured to carry the car. The connecting portion is located between two vertical portions and is configured to connect the vertical portions.

Further, connecting portions are arranged at both an upper end and a lower end of the vertical portions. The hoisting machine is fixed on the connecting portion at the lower part of the vertical portions and is located at the rear side of the car.

Further, the hoisting machine is arranged with left-right symmetry, and its symmetry center line is located at a middle position of the two vertical portions. An axis line of the traction sheave of the hoisting machine and a center line in a width direction of the connecting portion are located in a same vertical plane. The center line in the width direction of the connecting portion extends along the length direction of the connecting portion, which is the symmetry center line between the side of the connecting portion away from the car and the side close to the car.

Further, a diameter of the traction sheave of the hoisting machine is greater than a width of the connecting portion, so that the traction rope protrudes from a side of the traction sheave away from the car, then extends vertically upward and is fixed.

Further, the home elevator includes a frame arranged in the hoistway, and the hoisting machine and the support bracket move synchronously in the hoistway along the frame.

Further, a crossbeam is arranged at an upper part of the hoistway, and an upper end of the traction rope is fixed on the crossbeam. A projection of the crossbeam on a horizontal plane is located within a range of a projection of the hoistway on the horizontal plane.

Further, the crossbeam is fixed to the top of the frame; or, the crossbeam is fixed on an inner wall of the top of the hoistway.

Further, traction sheaves are arranged on both left and right sides of the hoisting machine. Two mounting seats are correspondingly arranged on the crossbeam. The mounting seats and the sides of the traction sheaves away from the car are located in a same vertical plane. Traction ropes on the two traction sheaves are respectively connected to the two mounting seats on the crossbeam.

Further, the frame has a guiding portion, and the support bracket has guide shoes cooperating with the guiding portion. The guiding portion and the guide shoes cooperate to guide the sliding of the support bracket in the hoistway.

Further, guide shoes are arranged at upper and lower ends of both left and right side walls of the support bracket, and the guiding portion is sliding grooves arranged in the frame to slidably cooperate with the two guide shoes on the same side.

The present disclosure also provides a home elevator including the arrangement for a hoisting machine in a forced-drive home elevator as described above.

The advantages of the present disclosure are: by directly arranging the hoisting machine on the side of the support bracket away from the car, it is only necessary to fix the traction rope on the crossbeam in the hoistway. There is no need to arrange a guide pulley structure at the top of the hoistway, nor does it occupy the space at the top or bottom of the hoistway. This improves the space utilization rate of the hoistway. Compared with traditional hoistway-internal forced-drive home elevators on the market, it does not need to increase the hoistway height, reducing the requirements for the hoistway height. It also does not need to make extra holes like the hoistway-external forced-drive home elevators, greatly reducing the installation difficulty and installation cost of the home elevator.

### BRIEF DESCRIPTION OF DRAWINGS

FIG. 1 is a structural schematic diagram of an arrangement for a hoisting machine in a forced-drive home elevator in an embodiment of the present disclosure;

FIG. 2 is a structural schematic diagram in a side view direction of FIG. 1;

FIG. 3 is a structural schematic diagram in a top view direction of FIG. 1;

FIG. 4 is a structural schematic diagram with a traction rope breakage monitoring device and a weighing device added on the basis of the arrangement in FIG. 1; and

FIG. 5 is a structural schematic diagram of an arrangement for a hoisting machine in a forced-drive home elevator in another embodiment of the present disclosure.

In the figures, the reference numerals include: Hoistway-1, Frame-2, Sliding groove-21, Support bracket-3, Guide shoe-31, Vertical portion-32, Horizontal portion-33, Connecting portion-34, Hoisting machine-4, Traction sheave-41, Traction rope-5, Crossbeam-6, Mounting seat-61, Car-7, Breakage monitoring device-8, Weighing device-9.

### DETAILED DESCRIPTION

The technical solutions described in the present disclosure are further explained below with reference to the accompanying drawings and embodiments.

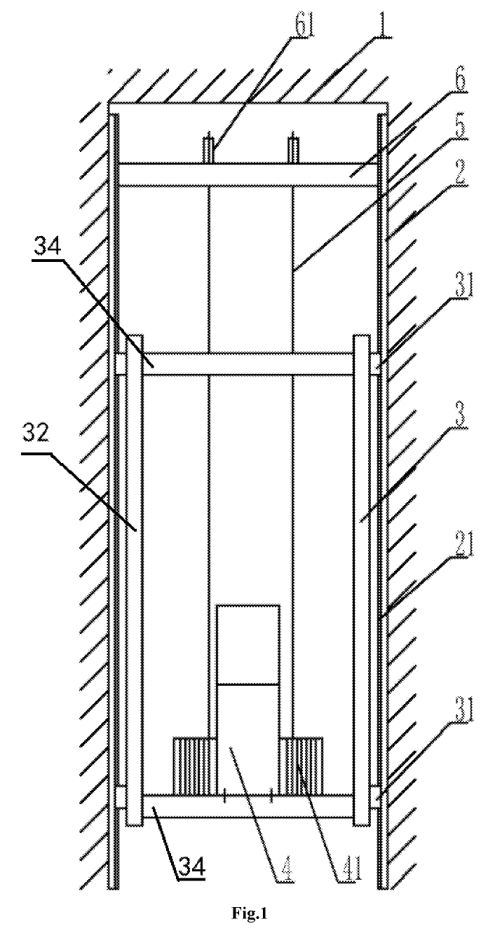

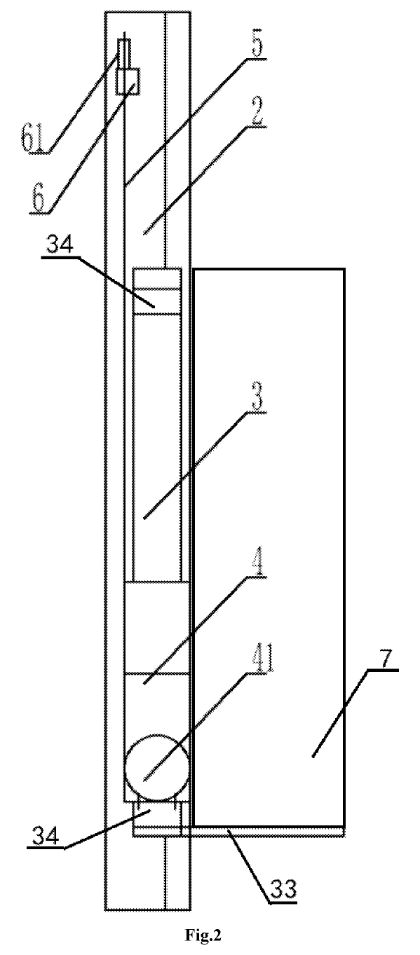

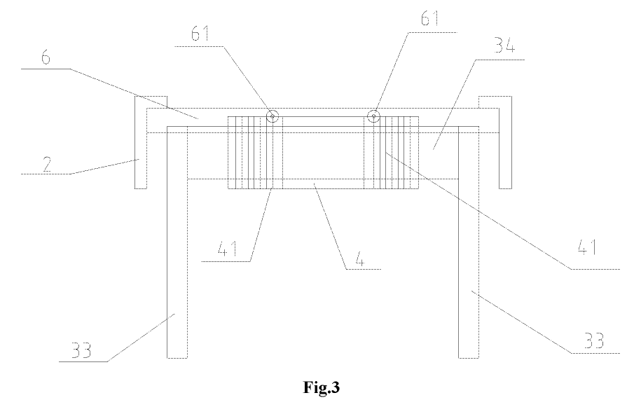

As shown in FIG. 1 to FIG. 3, the forced-drive home elevator of this embodiment includes a car 7, a support bracket 3, a hoisting machine 4, a traction rope 5, and a frame 2. The hoisting machine 4 is of a forced-drive type. The frame 2 is fixed on the inner wall of the hoistway 1, the car 7 is fixed on the support bracket 3, and the hoisting machine 4 is directly fixed on the support bracket 3. The traction rope 5 extends from the traction sheave 41 of the hoisting machine 4, extends vertically upward, and is fixed. The hoisting machine 4 has the traction sheave 41. One end of the traction rope 5 is wound on the traction sheave 41, and the other end of the traction rope 5 protrudes from the traction sheave 41 toward the back side of the support bracket 3, then extends vertically upward and is fixed. The hoisting machine 4 is used to drive the traction sheave 41 to rotate, causing the length of the traction rope 5 wound on the traction sheave 41 to increase or decrease, thereby driving the support bracket 3 and the car 7 to move in the vertical direction along the frame 2 within the hoistway 1. The hoisting machine 4 moves synchronously with the support bracket 3 and the car 7.

The frame 2 has a guiding portion, and the support bracket 3 has guide shoes 31 cooperating with the guiding portion. The guiding portion and the guide shoes 31 cooperate to guide the sliding of the support bracket 3 and the car 7 in the hoistway 1. The guiding portion is a guide rail or a sliding groove 21. In this embodiment, guide shoes 31 are arranged at the upper and lower ends of the side walls of the left and right vertical portions 32 of the support bracket 3. Sliding grooves 21 slidably cooperating with the two guide shoes 31 on the same side are arranged in the frame 2. The guide shoes 31 on the support bracket 3 are slidably arranged in the corresponding sliding grooves 21, thereby enabling the support bracket 3 to ascend and descend stably in the frame 2.

The support bracket 3 includes a vertical portion 32, a horizontal portion 33, and a connecting portion 34. The horizontal portion 33 is located at the bottom end of the vertical portion 32 and is used for carrying the car 7. The connecting portion 34 is located between the two vertical portions 32 and is used for connecting the vertical portions 32. Connecting portions 34 are arranged at both the upper end and the lower end of the vertical portions 32. A crossbeam 6 is arranged at the upper part of the hoistway 1, and the upper end of the traction rope 5 is fixed on the crossbeam 6. The projection of the crossbeam 6 on a horizontal plane is located within the range of the projection of the hoistway 1 on the horizontal plane; that is, the crossbeam 6 is completely located within the spatial range of the hoistway 1 and does not occupy space outside the hoistway 1. In this embodiment, the crossbeam 6 is fixed to the top of the frame 2.

The arrangement for the hoisting machine 4 in this embodiment is mainly such that the hoisting machine 4 is directly fixed on the connecting portion 34 at the lower part of the vertical portions 32 and is located at the rear side of the car 7. The traction rope 5 protrudes from the traction sheave 41 of the hoisting machine 4 toward the back side of the support bracket 3, then extends vertically upward and is fixed. The hoisting machine 4 does not interfere with the car 7, meaning there is no overlapping part between the projections of the hoisting machine 4 and the car 7 on the horizontal plane. Since the front-to-back width of the hoistway 1 is greater than the front-to-back width of the frame 2, a gap is left between the frame 2 and the rear side wall of the hoistway 1. Moreover, when the support bracket 3 is slidably arranged in the frame 2, a gap is also left between the support bracket 3 and the rear end of the frame 2. Therefore, when the hoisting machine 4 is fixed on the support bracket 3 located at the rear side of the car 7, a relatively large gap is left between the hoisting machine 4 and the rear side wall of the hoistway 1. At the same time, the diameter of the traction sheave 41 of the hoisting machine 4 is set to be larger than the width of the connecting portion 34, so that the traction rope 5 protrudes from the side of the traction sheave 41 away from the car 7, then extends vertically upward and is fixed. The back side or rear side in this embodiment refers to the side away from the car door panel.

In this embodiment, the hoisting machine 4 is arranged with left-right symmetry, and its symmetry center line is located at the middle position of the two vertical portions 32 of the support bracket 3. Meanwhile, the axis line of the traction sheave 41 of the hoisting machine 4 and the center line in the width direction of the connecting portion 34 are located in the same vertical plane. The center line in the width direction of the connecting portion 34 extends along the length direction of the connecting portion 34, which is the symmetry center line between the side of the connecting portion 34 away from the car and the side close to the car. Specifically, in this embodiment, the hoisting machine 4 has a double-ended structure, and traction sheaves 41 are arranged on both the left and right ends of the hoisting machine 4. The two traction sheaves 41 in the hoisting machine 4 protrude backward out of the connecting portion 34 of the support bracket 3. The two traction sheaves 41 on the hoisting machine 4 will not contact the rear side wall of the hoistway 1. The left-right symmetry center line of the hoisting machine 4 is vertically aligned with the left-right symmetry center line of the bottom wall (connecting portion 34) of the support bracket 3, meaning the hoisting machine 4 is located at the left-right symmetry center of the support bracket 3, ensuring the balance of the support bracket 3. Traction ropes 5 are fixed on both traction sheaves 41. In this embodiment, the traction rope 5 is a steel wire rope, and the connection structure between the traction rope 5 and the traction sheave 41 belongs to the prior art and will not be described in detail here.

In this embodiment, the crossbeam 6 for fixing the upper end portion of the traction rope 5 is arranged at the top of the frame 2. Two mounting seats 61 are arranged symmetrically left and right on the crossbeam 6. The two mounting seats 61 are respectively vertically aligned with the back sides of the two traction sheaves 41 protruding backward out of the support bracket 3, so that the traction ropes 5 are arranged vertically on the back side of the support bracket 3. The mounting seats 61 and the sides of the traction sheaves 41 away from the car 7 are located in the same vertical plane. The traction ropes 5 on the two traction sheaves 41 extend vertically upward and are respectively connected to the two mounting seats 61 on the crossbeam 6. The mounting seat 61 includes a damping spring.

When the hoisting machine 4 drives the two traction sheaves 41 to rotate in the forward direction, the two traction ropes 5 can be respectively wound onto the corresponding traction sheaves 41. As the traction ropes 5 are wound, they drive the hoisting machine 4 and the support bracket 3 to ascend together. Since the support bracket 3 is used to install the car 7, the ascent of the car 7 in the elevator can be achieved. When the hoisting machine 4 drives the two traction sheaves 41 to rotate in the reverse direction, the traction ropes 5 are released, and the hoisting machine 4 and the support bracket 3 descend together, causing the car 7 in the elevator to descend. While the car 7 moves up and down within the hoistway 1, the hoisting machine 4 moves synchronously.

The arrangement for the hoisting machine 4 in this embodiment has the following advantages:

1. The hoisting machine 4 is directly installed at the lower position on the back side of the support bracket 3, so that the traction rope 5 protrudes from the traction sheave 41 of the hoisting machine 4 toward the back side of the support bracket 3, then extends vertically upward and is fixed on the crossbeam 6. That is, the traction rope 5 is arranged on the rear side of the support bracket 3, rather than on the front side of the support bracket 3. Arranging the traction rope 5 at a position away from the car 7 can reduce the arrangement space between the support bracket 3 and the car 7. There is no need for the traction rope 5 to pass between the support bracket 3 and the car 7; the suspension arrangement of the traction rope 5 can be achieved only in the space behind the support bracket 3. This makes the overall structure of the support bracket 3 and the car 7 more compact and improves the overall utilization rate of the space of the hoistway 1.

2. The traction rope 5 is arranged on the rear side of the support bracket 3, which further facilitates the fixing of the upper end of the traction rope 5. The upper end of the traction rope 5 can be directly fixed on the crossbeam 6 at the upper end of the frame 2. The crossbeam 6 is fixedly connected to the upper end of the frame 2. Pulley structures such as diverting pulleys are not required at the upper end of the hoistway 1, which greatly simplifies the fixing of the upper end of the traction rope 5, saves arrangement space, improves the overall utilization rate of the space of the hoistway 1, and simultaneously makes installation simpler and more convenient.

3. In some embodiments, the crossbeam 6 for suspending the traction rope 5 is directly fixed to the upper end of the frame 2 without needing to be connected to the building structure. Through the crossbeam 6, the self-connection and self-support of the traction rope 5 of the elevator and the elevator frame 2 can be achieved. There is no need to consider increasing the force-bearing requirements for components such as diverting pulleys used for the traction rope 5, which greatly reduces the civil engineering requirements for elevator installation, facilitates house building structure design, and reduces construction costs.

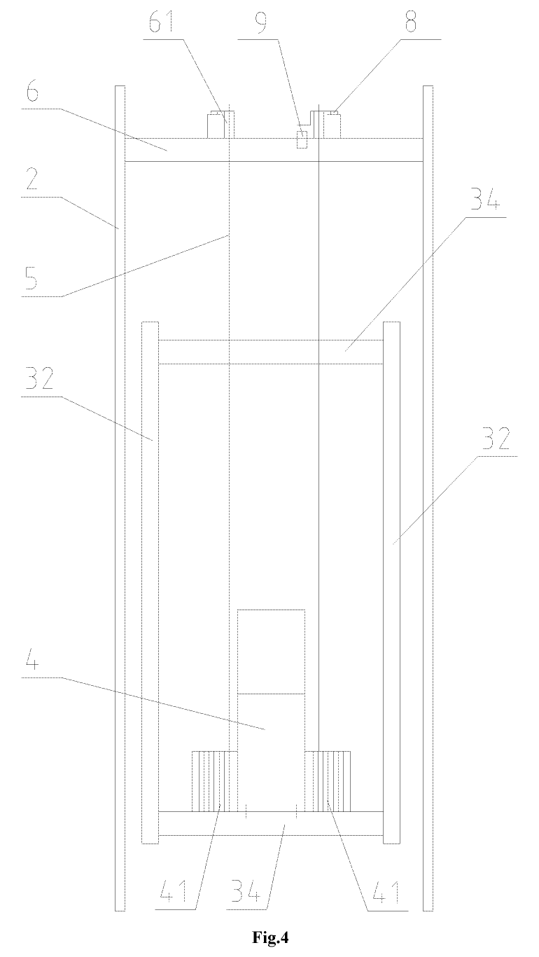

4. Since the traction rope 5 is directly connected and fixed to the crossbeam 6 without devices such as diverting pulleys it is easier to implement some auxiliary functions of the elevator. For example, a weighing device 9 can be arranged on the crossbeam 6. When the load of the car 7 changes, load weighing of the elevator is achieved through the change in the compression amount of the mounting seat 61 (damping spring) at the upper end of the traction rope 5, serving the function of overload protection. Similarly, a breakage monitoring device 8 for the traction rope 5 can be added. When the traction rope 5 breaks, the mounting seat 61 (damping spring) at the upper end of the traction rope 5 extends, causing the breakage monitoring device 8 to act, serving the function of monitoring protection when the traction rope 5 breaks, as shown in FIG. 4.

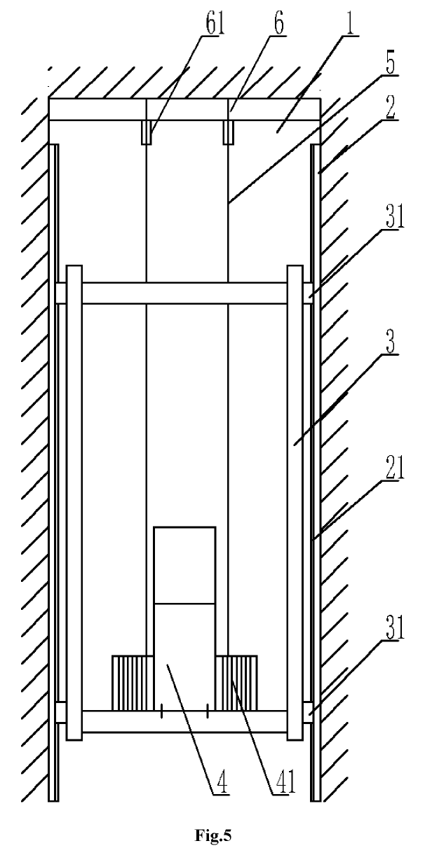

In other embodiments, if the household height space within the building is limited, the crossbeam 6 can be fixed on the inner wall of the top of the hoistway 1, as shown in FIG. 5, to further save the space of the hoistway 1.

Various examples described below and various combinations of these examples will now be described.

1. An example provides an arrangement for a hoisting machine in a forced-drive home elevator, including: a hoistway installed with a frame, and a support bracket. A car is installed on the support bracket. The hoisting machine is of a forced-drive type. The support bracket is slidably disposed (slidingly set) in the frame. The hoisting machine is installed in the support bracket. The hoisting machine does not interfere with the car, that is, projections of the hoisting machine and the car on a horizontal plane do not overlap. A traction rope is fixed on a traction sheave of the hoisting machine. A crossbeam is fixedly arranged above the support bracket, and the upper end of the traction rope is fixedly connected to the crossbeam.

2. According to the arrangement provided in Example 1, wherein the hoisting machine is fixed on a bottom wall of the support bracket and located at a rear side of the car. The traction sheave in the hoisting machine protrudes backward out of the support bracket, and the traction rope on the traction sheave connects vertically upward to the crossbeam.

3. According to the arrangement provided in any of the preceding examples, wherein the hoisting machine is of a double-ended structure, and traction sheaves are arranged on both left and right ends of the hoisting machine. A left-right symmetry center line of the hoisting machine is vertically aligned with a left-right symmetry center line of the bottom wall of the support bracket. Two traction ropes on the two traction sheaves on the hoisting machine are both connected vertically upward to the crossbeam.

4. According to the arrangement provided in any of the preceding examples, wherein two mounting seats are arranged symmetrically left and right on the crossbeam. The two mounting seats are respectively vertically aligned with the back sides of the two traction sheaves protruding backward out of the support bracket. The traction ropes on the two traction sheaves are respectively connected to the two mounting seats on the crossbeam.

5. According to the arrangement provided in any of the preceding examples, wherein guide shoes are arranged at upper and lower ends of both left and right side walls of the support bracket. Sliding grooves slidably cooperating with the two guide shoes on the same side are arranged in the frame.

6. Another example provides an arrangement for a hoisting machine in a forced-drive home elevator, wherein the home elevator includes a support bracket, a hoisting machine, and a traction rope. The hoisting machine is of a forced-drive type. The hoisting machine is fixedly installed on the support bracket and moves synchronously with the support bracket. The hoisting machine has a traction sheave. One end of the traction rope is wound on the traction sheave, and the other end of the traction rope protrudes from the traction sheave toward the back side of the support bracket, then extends vertically upward and is fixed. The hoisting machine is configured to drive the traction sheave to rotate, so that a length of the traction rope wound on the traction sheave increases or decreases, thereby driving the support bracket and the hoisting machine to move.

7. According to the arrangement provided in any of the preceding examples, wherein the support bracket includes a vertical portion, a horizontal portion, and a connecting portion. The horizontal portion is located at a bottom end of the vertical portion and is configured to carry the car. The connecting portion is located between two vertical portions and is configured to connect the vertical portions.

8. According to the arrangement provided in any of the preceding examples, wherein connecting portions are arranged at both an upper end and a lower end of the vertical portions. The hoisting machine is fixed on the connecting portion at the lower part of the vertical portions and is located at the rear side of the car.

9. According to the arrangement provided in any of the preceding examples, wherein the hoisting machine is arranged with left-right symmetry, and its symmetry center line is located at a middle position of the two vertical portions. An axis line of the traction sheave of the hoisting machine and a center line in a width direction of the connecting portion are located in a same vertical plane. The center line in the width direction of the connecting portion extends along the length direction of the connecting portion, which is the symmetry center line between the side of the connecting portion away from the car and the side close to the car.

10. According to the arrangement provided in any of the preceding examples, wherein a diameter of the traction sheave of the hoisting machine is greater than a width of the connecting portion, so that the traction rope protrudes from a side of the traction sheave away from the car, then extends vertically upward and is fixed.

11. According to the arrangement provided in any of the preceding examples, wherein the home elevator includes a frame arranged in the hoistway, and the hoisting machine and the support bracket move synchronously in the hoistway along the frame.

12. According to the arrangement provided in any of the preceding examples, wherein a crossbeam is arranged at an upper part of the hoistway, and an upper end of the traction rope is fixed on the crossbeam. A projection of the crossbeam on a horizontal plane is located within a range of a projection of the hoistway on the horizontal plane.

13. According to the arrangement provided in any of the preceding examples, wherein the crossbeam is fixed to the top of the frame; or, the crossbeam is fixed on an inner wall of the top of the hoistway.

14. According to the arrangement provided in any of the preceding examples, wherein traction sheaves are arranged on both left and right sides of the hoisting machine. Two mounting seats are correspondingly arranged on the crossbeam. The mounting seats and the sides of the traction sheaves away from the car are located in a same vertical plane. Traction ropes on the two traction sheaves are respectively connected to the two mounting seats on the crossbeam.

15. According to the arrangement provided in any of the preceding examples, wherein the frame has a guiding portion, and the support bracket has guide shoes cooperating with the guiding portion. The guiding portion and the guide shoes cooperate to guide the sliding of the support bracket in the hoistway.

16. According to the arrangement provided in any of the preceding examples, wherein guide shoes are arranged at upper and lower ends of both left and right side walls of the support bracket, and the guiding portion is sliding grooves arranged in the frame to slidably cooperate with the two guide shoes on the same side.

17. According to the arrangement provided in any of the preceding examples, wherein the traction rope is a steel wire rope.

18. Yet another example provides a home elevator including the arrangement for a hoisting machine in a forced-drive home elevator according to any of the preceding examples.

Finally, it should be noted that the above embodiments are only used to illustrate the technical solutions of the present disclosure rather than limit them. Although the present disclosure has been described in detail with reference to the above embodiments, those of ordinary skill in the art should understand that modifications or equivalent replacements can still be made to the specific implementations of the present disclosure, and any modification or equivalent replacement that does not depart from the spirit and scope of the present disclosure shall be covered within the protection scope of the claims of the present disclosure.

1. An arrangement for a hoisting machine in a forced-drive home elevator, comprising: a hoistway installed with a frame, and a support bracket installed with a car, wherein the hoisting machine is of a forced-drive type, the support bracket is slidably disposed in the frame; the hoisting machine is installed in the support bracket; projections of the hoisting machine and the car on a horizontal plane do not overlap; a traction rope is fixed on a traction sheave of the hoisting machine; a crossbeam is fixedly arranged above the support bracket; and the traction rope is fixedly connected to the crossbeam.

2. The arrangement according to claim 1, wherein the hoisting machine is fixed on a bottom wall of the support bracket and located at a rear side of the car; the traction sheave in the hoisting machine protrudes backward out of the support bracket; and the traction rope on the traction sheave connects vertically upward to the crossbeam.

3. The arrangement according to claim 2, wherein the traction sheaves are arranged on both left and right ends of the hoisting machine; a left-right symmetry center line of the hoisting machine is vertically aligned with a left-right symmetry center line of the bottom wall of the support bracket; and two traction ropes on the two traction sheaves on the hoisting machine are both connected vertically upward to the crossbeam.

4. The arrangement according to claim 3, wherein two mounting seats are arranged symmetrically left and right on the crossbeam; the two mounting seats are respectively vertically aligned with the two traction sheaves protruding backward out of the support bracket; and the traction ropes on the two traction sheaves are respectively connected to the two mounting seats on the crossbeam.

5. An arrangement for a hoisting machine in a forced-drive home elevator, wherein the home elevator comprises a support bracket, a hoisting machine, and a traction rope, and the hoisting machine is of a forced-drive type,wherein the hoisting machine is fixedly installed on the support bracket and moves synchronously with the support bracket; the hoisting machine has a traction sheave; one end of the traction rope is wound on the traction sheave, and the other end of the traction rope protrudes from the traction sheave toward the back side of the support bracket, then extends vertically upward and is fixed; the hoisting machine is configured to drive the traction sheave to rotate, so that a length of the traction rope wound on the traction sheave increases or decreases, thereby driving the support bracket and the hoisting machine to move.

6. The arrangement according to claim 5, wherein the support bracket comprises a vertical portion, a horizontal portion, and a connecting portion; the horizontal portion is located at a bottom end of the vertical portion and is configured to carry the car; and the connecting portion is located between two vertical portions and is configured to connect the vertical portions.

7. The arrangement according to claim 6, wherein the connecting portions are arranged at both an upper end and a lower end of the vertical portions; and the hoisting machine is fixed on the connecting portion at the lower part of the vertical portions and is located at the rear side of the car.

8. The arrangement according to claim 6, wherein the hoisting machine is arranged with left-right symmetry, and its symmetry center line is located at a middle position of the two vertical portions; and an axis line of the traction sheave of the hoisting machine and a center line in a width direction of the connecting portion are located in a same vertical plane.

9. The arrangement according to claim 6, wherein the diameter of the traction sheave of the hoisting machine is greater than the width of the connecting portion, so that the traction rope protrudes from a side of the traction sheave away from the car, then extends vertically upward and is fixed.

10. The arrangement according to claim 5, wherein the home elevator comprises a frame arranged in the hoistway, and the hoisting machine and the support bracket move synchronously in the hoistway along the frame.

11. The arrangement according to claim 5, wherein a crossbeam is arranged at an upper part of the hoistway, and an upper end of the traction rope is fixed on the crossbeam; and a projection of the crossbeam on a horizontal plane is located within a range of a projection of the hoistway on the horizontal plane.

12. The arrangement according to claim 11, wherein the crossbeam is fixed to the top of the frame; or, the crossbeam is fixed on an inner wall of the top of the hoistway.

13. The arrangement according to claim 11, wherein the traction sheaves are arranged on both left and right sides of the hoisting machine; two mounting seats are correspondingly arranged on the crossbeam; the mounting seats and the sides of the traction sheaves away from the car are located in a same vertical plane; and traction ropes on the two traction sheaves are respectively connected to the two mounting seats on the crossbeam.

14. The arrangement according to claim 1, wherein the frame has a guiding portion, and the support bracket has guide shoes cooperating with the guiding portion; and the guiding portion and the guide shoes cooperate to guide the sliding of the support bracket in the hoistway.

15. The arrangement according to claim 14, wherein the guide shoes are arranged at upper and lower ends of both left and right side walls of the support bracket; and the guiding portion is sliding grooves arranged in the frame to slidably cooperate with the two guide shoes on the same side.

16. The arrangement according to claim 5, wherein the frame has a guiding portion, and the support bracket has guide shoes cooperating with the guiding portion; and the guiding portion and the guide shoes cooperate to guide the sliding of the support bracket in the hoistway.

17. The arrangement according to claim 16, wherein the guide shoes are arranged at upper and lower ends of both left and right side walls of the support bracket; and the guiding portion is sliding grooves arranged in the frame to slidably cooperate with the two guide shoes on the same side.

18. A home elevator, comprising: the arrangement for the hoisting machine in the forced-drive home elevator according to claim 1.

19. A home elevator, comprising: the arrangement for the hoisting machine in the forced-drive home elevator according to claim 5.
